(19) United States
(12) Patent Application Publication
(10) Pub. No.: US 2009/0127006 A1
(43) Pub. Date: May 21, 2009

(54) Information Management in an Electronic Pen Arrangement

(76) Inventor: Stefan Lynggaard, Lund (SE)

Correspondence Address: BIRCH STEWART KOLASCH & BIRCH, PO BOX 747, FALLS CHURCH, VA, 22040-0747, US

(21) Appl. No.: 12/084,638

(22) PCT Filed: Nov. 9, 2006
(86) PCT No.: PCT/SE2006/001270

§ 371 Date: May 7, 2008

Related U.S. Application Data
(60) Provisional application No. 60/735,894, filed on Nov. 14, 2005.

(30) Foreign Application Priority Data
Nov. 11, 2005 (SE) 0502487.2

(51) Int. Cl. G06F 3/033

(52) U.S. Cl. 178/19.01

(57) ABSTRACT

An electronic pen (101) implements a method for information management, which controls association of information related to different position areas (104′, 105A′, 105B′) on a reference surface (106). The reference surface comprises a plurality of individually addressable position pages (105A′, 105B′). The pen has a position detector for detecting positions on the reference surface, each position being associated with a recording time. The pen also has a memory (108) for holding definition data which defines at least one selection area (104′) on the reference surface. A position processor in the pen maps the detected positions against the definition data. When the position processor identifies that a detected position falls within the selection area (104′), it selects at least one of the position pages (105A′, 105B′) based on further detected positions and according to a temporal selection criterion. The criterion typically tells the processor what further positions to analyze and how to analyze them to select the position page(s). The selection area (104′) may be associated with a predetermined action to be taken by the position processor with respect to the selected position page (105A′, 105B′), for example associating a time-stamped data item with the selected position page (105A′, 105B′) and/or deriving such a data item.

### FIELD OF THE INVENTION

The present invention generally relates to information management in an electronic pen arrangement, and in particular to controlling association of information related to different position areas on a reference surface.

### BACKGROUND ART

Information management systems for managing handwritten information are known; see e.g. US 2003/0061188, US 2003/046256 and US 2002/0091711. In these systems an electronic pen records pen strokes made on a product provided with a position code that codes a plurality of absolute positions on the product. The pen records the pen strokes on the product surface by imaging the position code at the tip of the pen and decoding the encoded positions so that a sequence of time-stamped positions reflecting the pen movement is obtained.

The position code on each product is only a small part of a much larger abstract position-coding pattern, which defines an imaginary surface or reference surface of positions.

The operation of the electronic pen is controlled based upon definition data stored in the pen. The definition data associates different areas of the reference surface with different pen functions. Such areas are denoted functional areas or “pidgets”, and the pen functions may include giving audible, visual or tactile feedback to the user, outputting detected positions to an external device, deleting pen strokes from pen memory, etc. Remaining areas on the reference surface, which are not associated with any function, are denoted “writing areas” since the default operation of the pen is to record pen strokes. Thus, by mapping detected positions against the definition data, the pen is automatically controlled to record pen strokes and to selectively execute functions.

Often, these functions operate on a specific set of detected positions. In the commercial embodiment developed by the present Applicant, and described in aforesaid US 2003/0061188, the definition data includes predefined associations between writing areas and pidgets. More specifically, the abstract pattern is divided into so-called pattern pages of a given size. Normally, each pattern page includes a writing area and one or more pidgets, where the pidget function operates on positions detected within the pattern page that contains the pidget, or within a set of pattern pages associated with this pattern page (e.g. a “book” of pattern pages). Thus, the selection of positions to be processed by an invoked pidget function is based on a predefined spatial criterion.

A coded product is generated by applying position code corresponding to one or more parts of a specific pattern page to a base surface, e.g. a sheet of paper, plastic, cardboard, etc. Thus, a product designer desiring to invoke a particular pen function, simply applies the corresponding position code to the base surface, e.g. by printing.

This implementation makes the pen operation transparent to the user, who can work with the electronic pen as with normal pen and paper, but it also requires the pattern pages to accommodate many different pidgets, in order not to unduly restrict the product design.

An alternative solution, which is more flexible with respect to product design, has been suggested by the present Applicant in US 2002/0011989. Here, pidgets and writing areas on a product surface are taken from spatially spaced sections of the reference surface. A pidget and a writing area can be dynamically connected by the pen user drawing a continuous line from one to the other on the product surface. The resulting electronic pen stroke will include a spatial discontinuity, a jump, on the reference surface. Whenever the pen identifies such a jump, it will derive any pen strokes recorded on the connected writing area and then operate the function of the connected pidget on these strokes.

US 2003/0107558 discloses another technique of associating position data. Apart from the above-mentioned pattern pages, the reference surface includes a settings page, on which different areas are associated with different settings in the system, such as different visual properties of recorded pen strokes. All recorded pen strokes are stored in pen memory in association with a session ID, which identifies the working session during which the pen strokes were recorded. When the pen is instructed to process pen strokes on a particular pattern page, it also derives from the settings page any pen strokes that have a relevant session ID with respect to the session ID of the pen strokes of the particular pattern page. Thereby, the pen or a receiving device is able to identify any selected settings and allocate these settings to the appropriate pen strokes on the pattern page, based upon the session ID and the recording time of the different pen strokes. This technique of associating a selected setting to pen strokes presumes that the selected setting is applicable to all subsequently recorded pen strokes throughout the same working session, or until another setting is selected.

### SUMMARY OF THE INVENTION

The object of the invention is to provide an alternative technique of associating information related to position areas on a reference surface.

Another object is to provide such a technique which is general and flexible.

These objects of the invention are at least partly achieved by means of an electronic pen arrangement of claim 1, a method of claim 25, a computer-readable storage medium of claim 36, and a device according to claim 37.

### BRIEF DESCRIPTION OF THE DRAWINGS

The invention will now be described in more detail by way of examples, reference being had to the accompanying schematic drawings.

FIG. 1A illustrates an exemplifying embodiment of an information handling system which is based on an abstract position-coding pattern.

FIG. 1B illustrates an embodiment of a position processor in the information handling system of FIG. 1A.

FIG. 2 illustrates a logical partitioning of an abstract position-coding pattern into an addressable tree structure of pattern pages.

FIG. 3 illustrates the relation between a pen-resident template definition and a position-coded product.

FIG. 4 is a cross-sectional view of an electronic pen that may be used in the system of FIG. 1A.

FIGS. 5A-5D show different examples of how a temporal selection area may be used together with an input area.

FIGS. 6A-6E illustrate different contexts in which temporal selection areas may be used.

FIG. 7 illustrates how associated data may be coded in the margin of a pattern page.

### DETAILED DESCRIPTION OF THE INVENTION

The following description starts out by explaining some basic principles of an embodiment of the invention. Then, an information management system implementing these principles is described in detail, whereupon different uses of the invention are exemplified.

### General

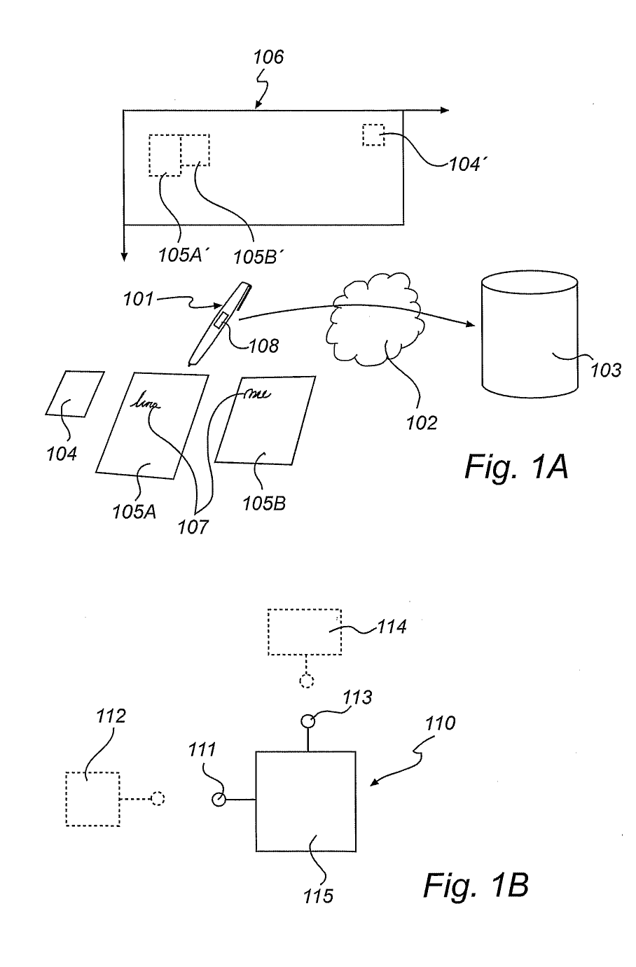

FIG. 1A illustrates a system for electronic recording and processing of handwriting. The system includes an electronic pen 101 which records and outputs data for transfer, via a data transfer channel 102, to a back-end processing apparatus 103. The system further includes a temporal selection field 104 and a plurality of input fields 105A, 105B (only two shown). All fields 104, 105A, 105B are provided on one or more tangible products, e.g. on a sheet of paper, cardboard or plastic, a display screen, etc. The system also includes a reference surface 106, which is an electronic representation of the coordinate system that defines available positions in the system. Specifically, the fields 104, 105A, 105B are assigned mutually unique sets of positions, each set of positions corresponding to a confined position area on the reference surface 106. For example, the positions of temporal selection field 104 belong to temporal selection area 104′, and the positions of input fields 105A, 105B belong to input areas 105A′, 105B′, respectively.

While being used for writing on the input fields 105A, 105B, the pen 101 senses its position on the reference surface 106. Based thereon, the pen generates electronic position sequences that represent physical strokes 107 made by the pen on the input fields 105A, 105B. Each such electronic pen stroke is stored in internal memory 108 of the pen together with a recording time and is uniquely associated, via its position content, with the originating input area 105A′, 105B′.

The pen 101 outputs pen strokes collated by input area. Thus, input areas 105A′, 105B′ act as containers of time-stamped pen strokes in the system. As will be described in the following, the temporal selection area 104′ may be used to indicate a particular input area to the pen.

The pen 101 is capable of sensing positions of the temporal selection area 104′. When it senses a position of area 104′, the pen 101 is automatically caused to try to select one or more of the plurality of input areas 105A′, 105B′ by analyzing preceding and/or succeeding positions. Thus, the selection of input area 105A′, 105B′ is based on a temporal or time-related criterion, which defines to the pen what further positions to analyze and how to analyze them. For example, the pen may select the originating input area 105A′, 105B′ of an immediately preceding or succeeding stroke. The criterion may define a time window with respect to the position detected in area 104′, so that the pen is caused to make its selection of input area by analyzing further positions detected within this time window. The time window may, for example, be given as a number of time units (e.g. seconds or milliseconds) in a reference time frame, a number of detected positions, or a number of detected strokes. It may be intuitive for the user if the time window extends forwards in time from the detection of area 104′. However, it is also possible for the time window to extend backwards in time from such detection, or both. The pen may, for example, select input area based on the most recently or least recently detected position/pen stroke within this time window.

FIG. 1B illustrates one embodiment of a position processor 110 which may provide the above functionality in the system of FIG. 1A. The processor 110 has a first interface 111 for receiving positions from position-generating circuitry 112, a second interface 113 for accessing a definition data repository 114, and a component 115 for area selection. The position processor 110 may be implemented in pen 101, e.g. as part of a regular data processor, with the repository 114 being part of aforesaid memory 108 (FIG. 1A).

The repository 114 stores definition data that defines the extent and location of areas 104′, 105A′ and 105B′ on the reference surface 106. The area selection component 115 is configured, in hardware and/or software, to map the positions received from circuitry 112 against the definition data of repository 114. When the component 115 identifies that a received position falls within area 104′, it selects one or more of the input areas 105A′, 105B′ based on aforesaid temporal selection criterion.

The position processor 110 may also be caused to operate a function on one or more pen strokes in the selected input area 105A′, 105B′ and/or in area 104′. Examples of such a function include outputting pen strokes on the selected input area from the pen, deleting strokes from pen memory 108, and subjecting strokes to handwriting recognition (HWR) processing. The function may instead affect the internal operation of the pen, for example by setting the pen in a bar code reading mode or an audio recording mode. The temporal selection area 104′ may identify the function to the pen, or alternatively the function may be given by a function selection area (not shown) touched by the pen 101 before or after the temporal selection area 104′. The function may alternatively be identified to the pen via a voice command, a dedicated button on the pen, by the pen recording positions forming a predetermined gesture in area 104′ or in the selected input area 105A′, 105B′, etc.

Alternatively or additionally, the position processor 110 may be caused to associate a particular data item with the selected input area 105A′, 105B′. The data item may be the result of the above-mentioned function, for example machine-coded characters resulting from HWR processing, or bar code or audio data recorded by the pen. Alternatively, the data item may be directly connected to area 104′ and/or aforesaid function selection area. For example, the data item may comprise pen strokes detected within area 104′ or data associated with area 104′, such as a unique predefined identifier of area 104′ or one or more machine-coded characters. The data item may instead be a parameter value which is pre-stored in pen memory 108 to indicate a property of the pen (pen identifier, software version, etc) or the pen user (home address, email address, bank account number, telephone number, etc). It is also possible that the data item is an image recorded by the pen.

Suitably, the data item is assigned a time stamp, in the same reference time frame as the pen strokes, so that the processing apparatus 103, or the pen 101 itself, is able to later retrace the order in which pen strokes and data items of a particular input area 105A′, 105B′ were created.

The above system provides distinct advantages in its various aspects. Above all, it allows a system designer to use input areas as containers of pen strokes, while still providing flexibility with respect to, i.a., selecting and associating areas on the reference surface, operating functions on selected pen strokes, and associating data items with input areas.

### Pen Control Via Coding Pattern

An implementation of the present invention will now be described as incorporated in a particular pen-and-paper infrastructure developed by the present Applicant. The infrastructure is based on the use of an abstract position-coding pattern, i.a. disclosed in U.S. Pat. No. 6,663,008; U.S. Pat. No. 6,674,427; and U.S. Pat. No. 6,667,695. The pattern is capable of coding a very large number of unique absolute positions, which jointly make up the above-mentioned reference surface. The area of the reference surface is much larger than the area of any practically conceivable product. The positions encoded on a product are positions on this reference surface and the origin of the position coordinates is the origin of the reference surface.

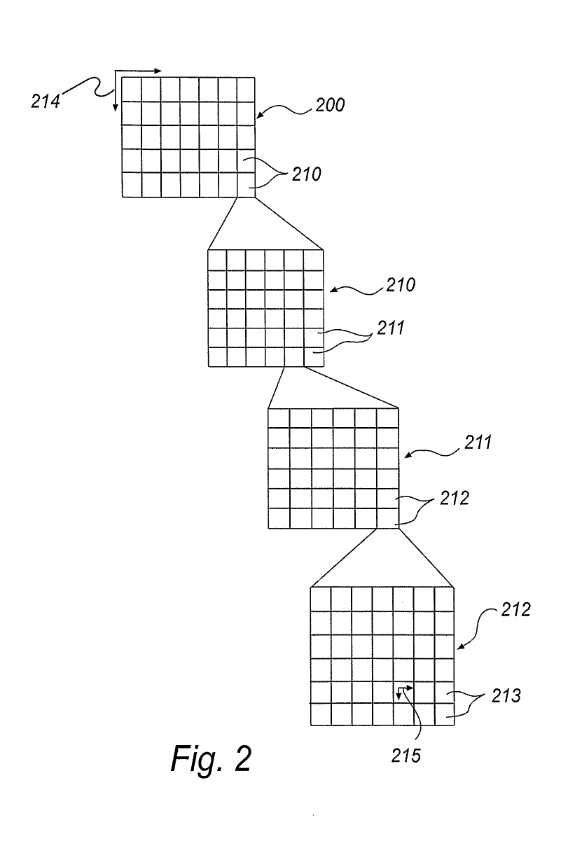

FIG. 2 illustrates how the reference surface 200, or the coding pattern, is divided into page units which are individually addressable in a hierarchy of page unit groups. In the example of FIG. 2, the reference surface 200 contains “segments” 210 which in turn are divided into a number of “shelves” 211, each containing a number of “books” 212 which are divided into a number of aforesaid page units 213, also called “pattern pages”. Suitably, all pattern pages have the same format within a particular level in the hierarchy of page unit groups. For example, some segments may consist of pattern pages in A4 format, while other segments consist of pattern pages in A5 format. The location of a certain pattern page on the reference surface can be noted as a page address of the form: segment.shelf.book.page, for instance 99.5000.1.1500, more or less like an IP address. For reasons of processing efficiency, the internal representation of the page address may be different, for example given as an integer of a predetermined length, e.g. 64 bits.

In one example, one or more segments consist of more than 26,000,000 pattern pages, each with a size of about 50×50 cm². In the commercial embodiment, at least one such segment is divided into 5,175 shelves, each consisting of 2 books with 2,517 pages each.

Each pattern page 213 may be regarded as an actual subset of the coding pattern, or as the absolute positions that are encoded by the subset. Each such absolute position may be represented as a global position in the coordinate system 214 of the reference surface 200, or as logical position, i.e. a page address and a local position in a predetermined coordinate system 215 within the relevant pattern page.

A product is formed to contain one or more pattern pages, typically by the corresponding position code being printed on a base surface. It is to be noted, however, that the position code on a product need not conform to a pattern page. Thus, one or more subsets from one or more pattern pages can be arbitrarily arranged on the product.

A suitable electronic pen records its movement on a product by sensing the position code thereon. The pen stores definition data which represents the partitioning of the reference surface (FIG. 2). Based on this definition data, the pen is capable of converting the global positions encoded by the position code into a logical position, i.e. the pen calculates a page address and a local position. Each pen stroke is stored in pen memory as a page address and a sequence of local positions. Thus, the pattern pages act as containers of pen strokes, each such container being identified by its page address.

The functionality of the pen is at least partly controlled by the pattern on the product, by the encoded positions being associated with different functions of the pen. To this end, the definition data stored by the pen includes one or more template definitions (“templates”) that define how the pen is to operate on the information that is detected from different parts of the position-coding pattern. In the illustrated infrastructure, a specific subset of the page hierarchy (segment, shelf, book, page) is associated with a given template, which thus is valid for all pattern pages within that specific subset. The template identifies any functional areas that may affect the operation of the pen. Such functional areas are denoted as “pidgets”.

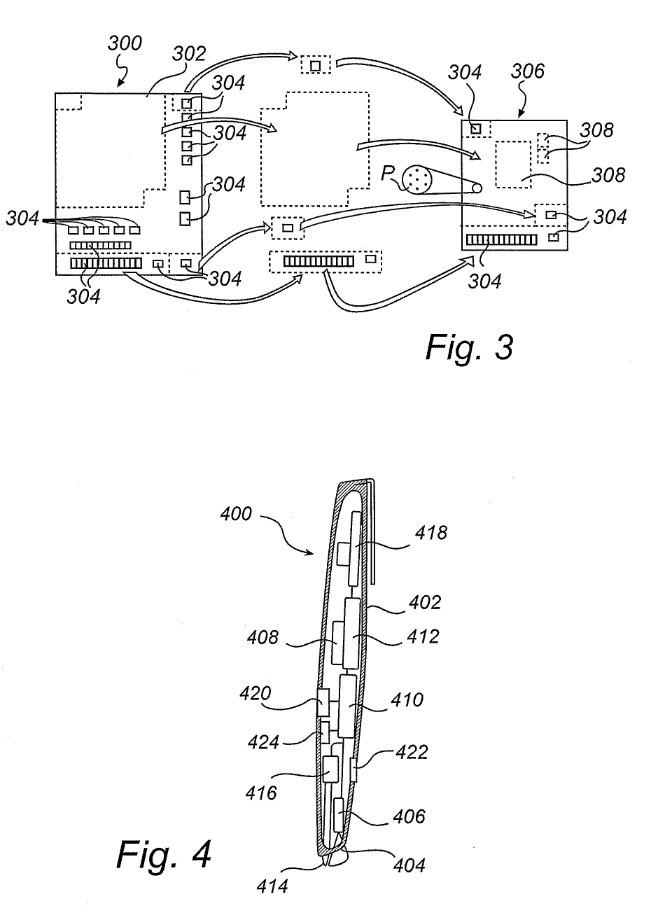

FIG. 3 further illustrates the interrelation between template 300, pattern page 302, and tangible product 306. The product 306 includes a position code P that defines positions within one or more pattern pages 302 (only one shown in FIG. 3). Although the pidgets 304 have a predefined placement and size within the pattern page 302, they may have any placement on the product 306. Thus, parts of the pattern page may be “cut out” and re-assembled in any fashion on the product. Whenever the pen is put down on a coded part of the product, it records a global position and is able to correlate this position to the relevant template and identify any function associated with the position. The product may also contain fields 308 that are only known to the processing apparatus (103 in FIG. 1A), which may associate dedicated processing instructions with such fields 308.

Specifically, the template identifies each pidget 304 by a pidget ID, and a size and placement in local positions in the local coordinate system (215 in FIG. 2) of the pattern page. The pidget ID is an identifier that determines the pidget function, by indicating a dedicated instruction set to be executed by the control system of the pen.

The pidget 304 may, i.a., indicate a trigger function, a service selection function, a device selection function, a local action function, a data selection function, an interpretation function, or a feedback function. The trigger function may cause the pen to output data, or enter a different data acquisition mode (such as recording of audio data or bar code data). The service selection function identifies a service, which may convey context information (e.g. email, fax, SMS) that affects the pen's processing of detected positions, and/or content information (e.g. indicating a level in the page hierarchy such as “page”, “book”, “shelf”) that affects the pen's selection of positions to be processed (e.g. causing the pen to select all positions originating from the page, book or shelf to which the service selection pidget belongs). The device selection function identifies a connection device for the pen (e.g. PC, mobile device, LAN access point). The local action function initiates an action that affects pen memory, such as deleting strokes. The data selection function maps detected positions to pen-resident data; e.g. a keyboard pidget may map positions to characters in the pen memory, or a shortcut pidget may map positions to communication addresses in the pen memory. The interpretation function may operate to convert one or more strokes within the pidget to machine-coded characters. The feedback function may cause the pen to activate an internal MMI, such as a vibrator, indicator lamp, display or speaker.

It is also possible that one and the same pidget is pre-assigned more than one function, e.g. a particular “send” pidget may be associated with not only a trigger function but also with a device selection function and a feedback function.

These pidget functions may operate on all pen strokes stored in pen memory, or on a specific subset thereof. The subset is generally given by the originating pattern page, i.e. the pattern page containing the pidget that initiated the pidget function. For example, the subset may be pen strokes detected on the originating pattern page, or on a group of pages containing this page, such as a book or shelf.

In a template, all positions not occupied by any pidget within a pattern page 302 are defined as belonging to a drawing or writing area. The positions detected in the drawing area are interpreted by the pen to be recorded and stored in pen memory as time-stamped pen strokes.

A special type of pidget function is a temporal selection function which at least causes the pen to select one or more pattern pages, e.g. based on any one of the above-mentioned temporal selection criteria. A pidget may, in addition to the temporal selection function, be pre-assigned one or more other pidget functions, such as the pidget functions discussed above. Any such other pidget function assigned to a temporal selection pidget may operate in relation to the selected pattern page(s), or to the temporal selection pidget. The temporal selection pidget may also be pre-assigned a storage function which stores a data item in association with the selected pattern page(s). The data item may result from the other pidget functions mentioned above.

As an alternative to this pre-assignment of plural functions, the temporal selection function may be designed to be assigned other functions dynamically. To this end, the temporal selection function may involve executing functions of other pidgets detected within the limits of the temporal criterion. For example, the pen may combine the functions of all other pidgets detected within the above-mentioned time window, or the functions of all other pidgets detected between detection of a temporal selection pidget and detection of a drawing area, or vice versa.

The temporal selection pidgets may be confined to a specific part of the reference surface, and the pen may thus store a dedicated temporal selection template for this specific part. However, it is also conceivable that temporal selection pidgets are defined on any one of the pattern pages of the reference surface, and thus are included in any one of the templates stored by the pen.

The various aspects of pidgets with temporal selection function will be further explained below with reference to different examples of use.

### Electronic Pen

FIG. 4 illustrates an embodiment of the above-mentioned pen 400, which has a pen-shaped casing or shell 402 that defines a window or opening 404, through which images are recorded. The casing contains a camera system, an electronics system and a power supply.

The camera system 406 comprises at least one illuminating light source, a lens arrangement and an optical image reader (not shown in the Figure). The light source, suitably a light-emitting diode (LED) or laser diode, illuminates a part of the area that can be viewed through the window 404, by means of infrared radiation. An image of the viewed area is projected on the image reader by means of the lens arrangement. The image reader may be a two-dimensional CCD or CMOS detector which is triggered to capture images at a fixed or variable rate, typically of about 70-100 Hz.

The power supply for the sensor device is advantageously a battery 408, which alternatively can be replaced by or supplemented by mains power (not shown).

The electronics system comprises a control unit 410 which is connected to a memory block 412. The control unit 410 is responsible for the different functions in the electronic pen and can advantageously be implemented by a commercially available microprocessor such as a CPU (“Central Processing Unit”), by a DSP (“Digital Signal Processor”) or by some other programmable logical device, such as an FPGA (“Field Programmable Gate Array”) or alternatively an ASIC (“Application-Specific Integrated Circuit”), discrete analog and digital components, or some combination of the above. The memory block 412 preferably comprises different types of memory, such as a working memory (e.g. a RAM) and a program code and persistent storage memory (a non-volatile memory, e.g. flash memory). Associated software is stored in the memory block 412 and is executed by the control unit 410 in order to provide a pen control system for the operation of the electronic pen. The pen control system is, i.a., capable of recording and storing pen strokes, identifying pidgets, and executing corresponding pidget functions.

The control unit 410 includes a timing circuit for defining the above-mentioned reference time frame in the pen. Based on time values output by this timing circuit, the control unit 410 assigns a time-stamp to each detected position or pen stroke. It may also assign a time value to any other data item that is to be stored in the memory block 412, as will be further discussed below.

The casing 402 also carries a pen point 414 which allows the user to write or draw physically on a surface by pigment-based marking ink being deposited thereon. The marking ink is suitably transparent to the illuminating radiation in order to avoid interference with the opto-electronic detection in the electronic pen. A contact sensor 416 is operatively connected to the pen point 414 to detect when the pen is applied to (pen down) and/or lifted from (pen up), and optionally to allow for determination of the application force. Based on the output of the contact sensor 416, the camera system 406 is controlled to capture images between a pen down and a pen up. The control unit 410 processes these images to generate a sequence of temporally coherent positions that electronically represent a physical pen stroke. The control unit 410 may also be capable of generating bar code data from the images provided by the camera system 406.

The electronics system further comprises a communications interface 418 for outputting data to a nearby or remote apparatus such as a computer, mobile telephone, PDA, network server, etc. The communications interface 418 may thus provide components for wired or wireless short-range communication (e.g. USB, RS232, radio transmission, infrared transmission, ultrasound transmission, inductive coupling, etc), and/or components for wired or wireless remote communication, typically via a computer, telephone or satellite communications network.

The pen may also include an MMI (Man Machine Interface) 420 which is selectively activated for user feedback. The MMI may include a display, an indicator lamp, a vibrator, a speaker, etc.

Still further, the pen may include one or more buttons 422 by means of which it can be activated and/or controlled, as well as a microphone 424 for recording of audio data.

### Exemplifying Use

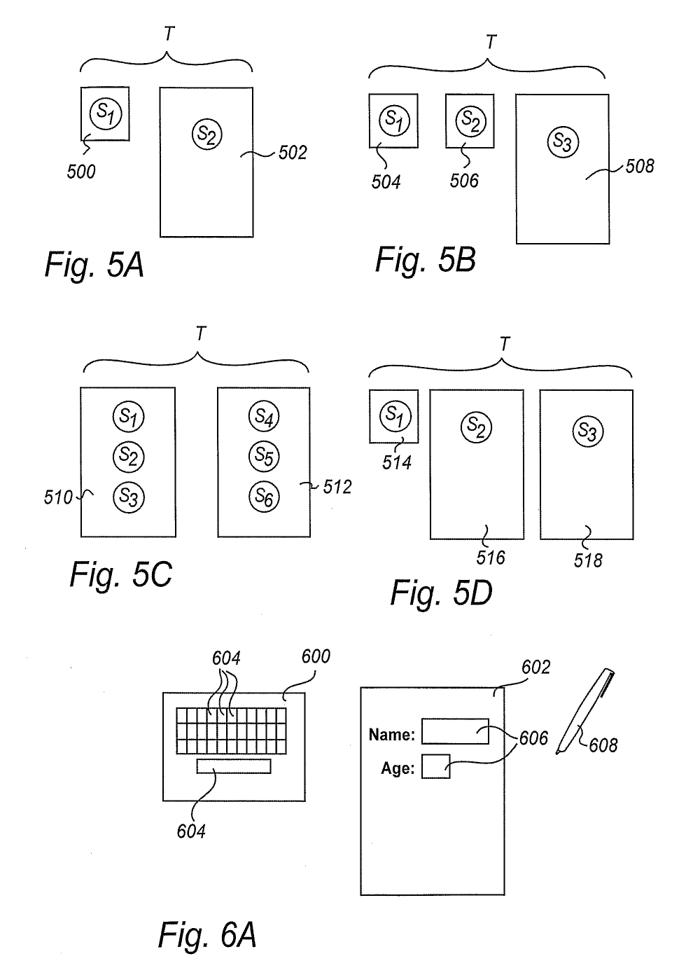

FIGS. 5A-5D exemplify different ways of using temporal selection pidgets for creating associations in a system as described above with reference to FIGS. 2-4.

In FIG. 5A, a pen user makes a pen stroke S1 on temporal pidget 500, and a pen stroke S2 on pattern page 502. Via the temporal criterion T, the pen is caused to operate pidget 500 on pattern page 502, e.g. by associating stroke S1 or the ID of pidget 500 with pattern page 502, and/or by operating a function of the temporal pidget 500 on stroke S2, and optionally on any other pen strokes detected on pattern page 502, and/or by associating the result of this operation with pattern page 502.

In FIG. 5B, a pen user makes a pen stroke S1 on temporal pidget 504, and a pen stroke S2 on pidget 506, which may or may not be temporal, and a pen stroke S3 on pattern page 508. In one variant, this use case would cause the pen to combine the functions of pidgets 504, 506, and operate the combined function on pattern page 508. For example, the pen may be controlled, following detection of temporal pidget 504, to combine the functions of all detected pidgets until a drawing area is detected, or the pen may be controlled to combine functions as long as the next pen stroke hits a temporal pidget. In another variant, this use case would cause the pen to operate the pidget function of pidget 506 on pattern page 508, i.e. only the function of the last-detected temporal pidget is operated on pattern page 508.

In FIG. 5C, a pen user makes a number of pen strokes S1-S3 on temporal pidget 510, followed by a number of pen strokes S4-S6 on pattern page 512. This may cause the pen to record and associate pen strokes S1-S3 with pattern page 512. In such a use case, the pidget function may cause the pen control unit to terminate any attempt to select a pattern page whenever the pen stroke in temporal pidget 510 is followed by another pen stroke in temporal pidget 510, but to select a pattern page which follows upon a pen stroke in temporal pidget 510.

In FIG. 5D, a pen user makes a pen stroke S1 on temporal pidget 514, followed by a pen stroke S2 on pattern page 516 and a pen stroke S3 on pattern page 518. Here, the pen may be controlled to associate pen stroke S1 or the ID of pidget 514 with both pattern pages 516, 518. Alternatively, the pen may be controlled to associate pattern page 516 with pattern page 518, e.g. if pidget 514 is assigned a function to associate all pattern pages touched by the pen within a given time window.

It is to be understood that the above are but examples of use cases, functions and temporal selection criteria. Further, in each use case, pidgets could be assigned other functions to achieve one and the same result from a user's perspective.

It may also be advantageous to associate the temporal selection pidget with a feedback function that controls the pen to signal each detection of a temporal selection pidget, and/or each associated selection of a pattern page, to the user, suitably by selectively activating the MMI (420 in FIG. 4). For example, the pen could vibrate on detection of the pidget and on selection of a pattern page.

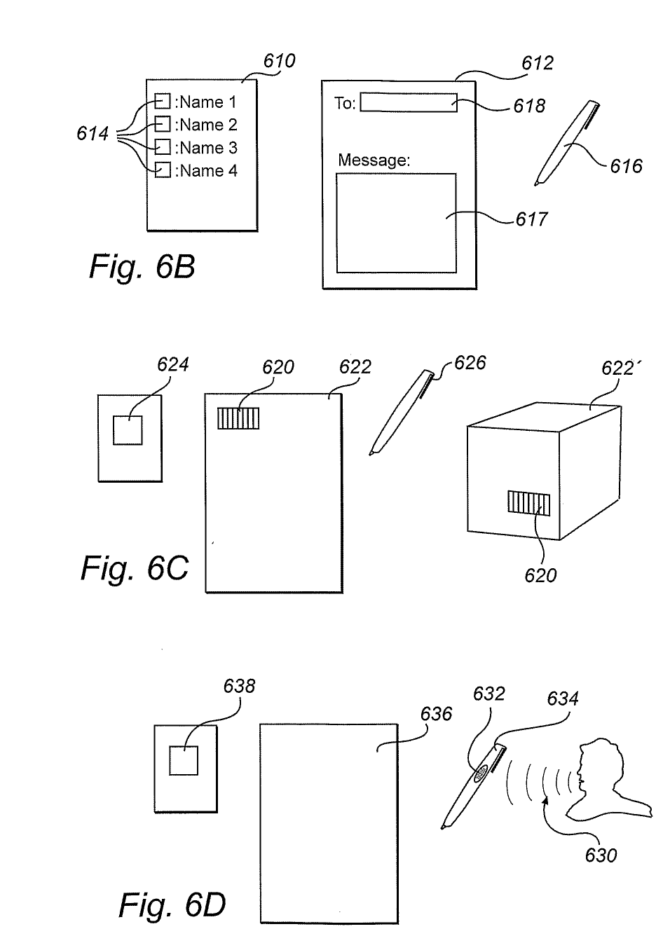

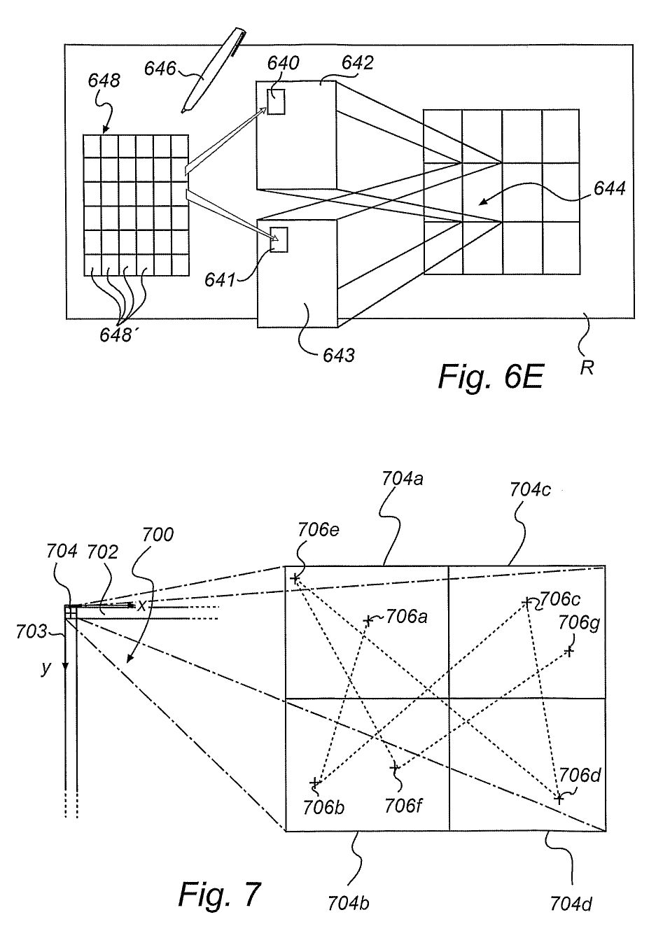

FIGS. 6A-6E illustrate different situations in which temporal selection pidgets may be used.

In FIG. 6A, a paper keyboard 600 is used together with a form 602. The keyboard is a pidget associated with a temporal selection function. The keyboard defines keys 604 that designate a respective character or keyboard operation (shift, caps lock, space, etc). When a pen user desires to input a set of characters for a particular field 606 on the form, e.g. “Name” or “Age”, he uses the pen 608 to tap the relevant keys 604 on the keyboard 600, and to tap the relevant field 606 on the form 602.

The keyboard pidget 600 is thus associated with a function that controls the pen 608 to assemble all strokes made on the keyboard pidget, and then associate these strokes with the pattern page of the first subsequent pen stroke that falls outside the keyboard pidget 600. All strokes are time-stamped. A back-end processing apparatus (not shown) that receives all data of form 602 is then able to identify the keyboard pidget 600 from the strokes that are associated with form 602, retrieve a definition of the keyboard pidget 600, and map the pen strokes to characters, using the definition. The order of the characters is given to the processing apparatus by the time stamps of the pen strokes. The processing apparatus is also able to associate the resulting set of characters with the relevant field on form 602, based on the location of the first pen stroke that follows upon the keyboard stroke(s).

Alternatively, the function may control the pen 608 to store a time-stamped identifier of each key 604 that is hit by the pen, instead of the actual pen strokes.

In yet another alternative, the memory unit of the pen 608 may contain a keyboard definition, allowing the pen control unit to map pen strokes within the keyboard pidget 600 to characters. In this case, the function may control the pen to associate a time-stamped set of machine-coded characters with the pattern page of the form 602.

In FIG. 6B, a shortcut list 610 is used together with an email form 612. The shortcut list contains a number of temporal selection pidgets 614, each having a unique ID and being associated with an email address. The association may be stored by the pen 616 or by the back-end processing apparatus (not shown). When a pen user desires to send pen strokes recorded in a message field 617 on the form 612 to an email recipient, he may use the pen 616 to tap one or more shortcut pidgets 614 of the intended recipient, and then to tap a destination field 618 on the form. Subsequently, the pen user instructs the pen 616 to output the data related to form 612. As in the example of FIG. 6A, the pen 616 may be controlled to associate either the pen stroke in the shortcut pidget 614, the ID of the shortcut pidget 614, or the email address itself, with the pattern page of the email form 612.

In FIG. 6C, a bar code 620 is used together with a form 622 and a temporal selection pidget 624. The bar code may be placed on the form 622 itself or on another item 622′. When a pen user desires to input bar code data, he uses the pen 626 to tap the temporal selection pidget 624, then places or sweeps the pen 626 across the bar code 620, and finally he taps or writes on the form 622. The bar code pidget 624 is associated with a function that sets the pen 626 in a bar code reading mode, in which its control unit decodes bar code data from one or more recorded images. The resulting bar code data, which may be provided with a time stamp in the reference time frame of the pen, is then associated with the pattern page of form 622 via the temporal selection criterion of pidget 624.

It is to be understood that the bar code 620 could be exchanged for any other one- or two-dimensional code, such as Data Matrix, MaxiCode, PDF417, Aztec code, etc, as well as dot codes developed by the present Applicant and described in US 2001/0038349 and WO 2006/001769.

In FIG. 6D, audio data 630 is recorded by a microphone 632 in the pen 634 and associated with a form 636. When a pen user desires to record audio data, he uses the pen 634 to tap a temporal selection pidget 638, then speaks into the microphone 632, and finally taps or writes on the form 636. The audio pidget 638 is thus associated with a function that controls the pen 634 to record audio data 630 via microphone 632. The resulting audio data 630, which may be provided with a time stamp in the reference time frame of the pen, is then associated with the pattern page of form 636 via the temporal selection criterion of pidget 638.

Alternatively, audio pidget 638 may be associated with a function that controls the pen 632 to derive the most recently recorded audio data and associate this data with the pattern page that is selected based on the temporal selection criterion of audio pidget 638.

FIG. 6E illustrates the use of temporal selection pidgets 640, 641 to distinguish between so-called copied forms 642, 643. Copied forms all include position code from one and the same pattern page 644 on the reference surface R. Thus, a pen or a back-end processing apparatus is unable to distinguish between data recorded from different instances of such forms. To this end, each form instance is provided with a unique temporal selection pidget 640, 641. In filling in form 642, 643, the pen user also taps temporal selection pidget 640, 641 with the pen 636. This causes the pen 646 to associate either the pen stroke in pidget 640, 641 or a unique ID of pidget 640, 641, with the pattern page 644 of the form 642, 643. Thereby, the pen and/or the back-end processing apparatus is able to distinguish one form instance from the other.

In all embodiments, use cases and situations described herein, the pen's memory unit may hold a template that explicitly associates the positions of each individual temporal selection pidget 640, 641 with a unique pidget ID. For reasons of memory efficiency, the template may instead include an algorithm for converting a given position into such a pidget ID. As exemplified in FIG. 6E, a confined area 648 on the reference surface R may be divided into a given array of subareas 648′, each subarea 648′ representing a pidget and containing a unique set of positions. The algorithm represents the layout of the array 648 with respect to its included positions. Based on any position in the confined area 648, the algorithm outputs a unique value which identifies the relevant subarea 648′ or pidget.

There are numerous other examples of functions that can be assigned to a temporal selection pidget, either statically or dynamically, for example:
Set visual property of pen strokes (e.g. color, line width, etc) either in the pen or at the back-end processing apparatus
Output pen strokes from pen
Grant access to various externally stored data (e.g. social security or personal number, telephone number, bank account number) for use in the processing of pen strokes by the processing apparatus
Operate HWR on pen strokes, either in the pen or at processing apparatus
Set interpretation context for HWR (e.g. digit, letter, bank account number, email address, lower case, upper case, etc)
Input page format parameter (page break, page columns, page margins)
Delete pen strokes, either from pen memory or at processing apparatus. In one example, the temporal selection pidget is assigned the function to delete all pen strokes on the selected pattern page(s). In another example, the pidget is assigned the function of deleting only pen strokes within a predefined field on the selected pattern page(s), the field being given by the positions of the selecting pen stroke, i.e. the pen user may tap a temporal selection pidget (“delete” pidget) and then tap the specific field for which pen strokes are to be deleted.
Derive a certain parameter value (e.g. pen ID, user's email address, user's name, pen SW version, etc) from pen memory

An application developer may have access to a pattern page containing a plurality of temporal selection pidgets of both identical and different sizes. The temporal selection criterion may differ among these pidgets, to provide an assortment of pidgets to the application developer. Some of these pidgets may be assigned a predetermined function to be executed by the pen control unit, for example as exemplified above. However, other pidgets may only be assigned the function of storing the pen stroke(s) detected in the temporal selection pidget, or its pidget ID, in association with the selected pattern page(s). The application developer may then assign to these pidgets external functions which are unknown to the pen. These external functions are only known to the back-end processing apparatus, which thus is able to operate the external function on the appropriate pen strokes, after having recreated the order in which they were detected by the pen.

To further exemplify the use of external functions, consider a form containing a drawing area from a certain pattern page, and two temporal selection pidgets. One of the pidgets is designated as “select strokes” on the form, and the other is designated as “delete” on the form. Whenever the user desires to delete any previously entered strokes in the drawing area, he taps on the “select strokes” pidget, encircles the strokes to be deleted, and taps the “delete” pidget. The “select strokes” pidget causes the pen to associate the ID of this pidget with the pattern page of the encircling stroke, and the “delete” pidget causes the pen to associate the ID of this pidget with the pattern page of the immediately preceding stroke. Thus, when the pen outputs the data belonging to the pattern page of the drawing area, it will output the previously entered pen strokes, the ID of the “select strokes” pidget, the encircling stroke, and the ID of the “delete” pidget. The back-end processing apparatus associates the ID of the “select strokes” pidget with the external function of treating the next pen stroke as an encircling pen stroke, and finding any other pen strokes within the encircling pen stroke. The processing apparatus associates the ID of the “delete” pidget with the external function of deleting any such other pen strokes. Clearly, the processing apparatus is capable of executing the action intended by the user.

### Associating Data to Pattern Page

In the above examples, the pen associates different data items with one or more pattern pages. This may be accomplished by the pen control unit storing the associated data item(s) together with the page address of the selected pattern page. Thereby the pen control unit can later search the pen memory based on page address, for example to compile relevant data for output. Alternatively, the pen control unit directly incorporates the associated data item(s) in a file which is allocated for this page address in pen memory.

When the pen is triggered to output data, the pen control unit may output a file or an http request via the communications interface of the pen. The file/request includes both relevant pen strokes and any associated data item (“associated data”). In one embodiment, the associated data is arranged in a dedicated part of the file/request. In another embodiment, which will be further described below, the associated data is instead encoded as pen stroke data on a specific pattern page. Thereby, the associated data can be transferred via an existing transfer system designed for the transfer of pen stroke data.

An example of the encoding of associated data as pen stroke data will now be given with reference to FIG. 7. In this example, the encoding process is carried out in the electronic pen. More particularly, the encoding process may be carried out in a encoding module, which receives associated data as an input and which outputs pen stroke-coded associated data as an output. In this embodiment it is assumed that the associated data is binary data or converted to binary data.

To the left, FIG. 7 schematically shows part of a pattern page 700 with a margin 702. Positions (x/y coordinates) within the pattern page 700 are defined in a local coordinate system 703. In this embodiment the 32*32 coordinate area 704 of the upper left corner of the pattern page 700 is reserved for pen stroke-coded associated data. This area 704 is divided into four quadrants 704a-704d, each one of 16*16 x/y coordinates, for reasons that will be evident below. The four quadrants are shown in enlarged scale to the right in FIG. 7.

Upon receipt of binary associated data, the pen converts each byte of the binary data to x/y coordinate data as follows:

$$\{ \begin{matrix}x = ( byte mod 16 ) + 16 \cdot ( int ( ( C I mod 4 ) \text{/} 2 ) ) \\ y = ( byte mod 16 ) + 16 \cdot ( C I mod 2 )\end{matrix}$$

where CI (Coordinate Index) indicates the ordinal number of the x/y coordinate (byte) in a sequence of x/y coordinates (bytes), “int” stands for “integer part of” and “mod” stands for “modulo”. Thus, the four least significant bits of an associated data byte will be coded as an x-coordinate, whereas the four most significant bits thereof will be coded as a y-coordinate.

With this encoding the x/y coordinates are sequentially placed in each one of the quadrants 704a-704d as is shown in the enlarged part of FIG. 7, where the crosses 706a-706g represent seven x/y coordinates and the broken line connecting the coordinates represent the corresponding stroke. The number of bytes of data defines the length of the “stroke” in the 32 by 32 coordinate area.

If more data bits need be coded in each position, the size of the quadrants can be increased.

One reason for placing the coordinates sequentially in the four quadrants of the position area 704 may be to make sure that the coordinates are ineligible for coordinate reduction by preventing any three successive coordinates from forming a straight line. Another reason may be to qualify the stroke as a stroke which includes non-pen stroke data.

It may be beneficial to indicate which type of associated data is coded in the margin stroke, e.g. barcode data, keyboard data, pen stroke data, pidget ID data, pen parameter data, etc. To this end, the coding process may add byte(s) of data indicating the kind of data to the sequence of data to be coded in the margin. Such an added byte may be converted in the same manner as the data to an x/y coordinate which may be have a predetermined place in the sequence of x/y coordinates.

When the binary data has been converted to a sequence of x/y coordinates, this sequence of coordinates may be is stored and processed in exactly the same way as an ordinary pen stroke.

When the pen stroke-coded associated data is received at the receiving side of the system, e.g. in the processing apparatus 103 of FIG. 1A, it is recognized as being associated data as a result of the coordinate area to which the coordinates belong. Before the coordinates are decoded to binary data, they are all translated to a coordinate in the first quadrant 704a. This is carried out as follows:

$$\{ \begin{matrix}x ( q 1 ) = x ( qi ) - 16 \cdot ( int ( ( C I mod 4 ) \text{/} 2 ) ) \\ y ( q 1 ) = y ( qi ) - 16 \cdot ( C I mod 2 )\end{matrix}$$

where q1 is quadrant 1, qi is quadrant i for i=1, 2, 3, 4, “int” stands for “integer part of” and “mod” stands for “modulo”.

Then the resulting quadrant 1 coordinates are decoded to binary data as follows:

Byte=16·(y mod 16)+x mod 16

Evidently the use of the corner area is but an example. Other margin areas may also be used. One example would be to use a 4096*16 coordinate area in the upper margin and a 16*4096 coordinate area in the left margin and to alternating code bytes or other chunks of data as positions in these two coordinate areas. Still further, different margin areas could be dedicated to different types of associated data, so that the type of associated data is given by its location in the margin. Furthermore, non-margin areas could be used for transferring associated data, provided that such non-margin areas are invalid for ordinary pen strokes in the system. In one embodiment, different areas are dedicated to different types of non-pen stroke data.

Other schemes for coding non-pen stroke data to coordinates may also be used.

The pen may under certain circumstances generate ordinary pen positions in the margin of the pattern page. Such pen stroke positions may be filtered off in the pen in order not to disturb the transfer of associated data. If they are not filtered off at the sender side, they can be removed at the receiver side. The back-end processing apparatus may e.g. recognize such pen stroke positions from their relation to previous or subsequent positions.

In the example above, the associated data is transferred as separate pen strokes which are distinguishable from ordinary pen strokes. As an alternative the ordinary pen strokes may be used for transferring associated data, e.g. by dedicating the least significant bit in each position in the ordinary pen strokes to the transfer of associated data.

In the embodiments described above, detection of a temporal selection pidget and any resulting processing all takes place in the control unit of the pen. The operations of the pen can, however, take place arbitrarily distributed among the pen and any external unit, such as a local computer, a mobile phone, a PDA, etc, the pen and the external unit forming a pen arrangement. In an opposite extreme to the illustrated embodiment, the pen is only arranged to output the recorded image data to the external unit, which executes, i.a., decoding of positions or bar code data from the image data, detection of pidgets and any resulting processing.

In the above embodiments, the partitioning of the reference surface is dynamic, in that the logical positions are calculated from decoded global positions. In an alternative embodiment, the coding pattern directly encodes a logical position. For example, U.S. Pat. No. 6,330,976 discloses a coding pattern in which coding cells are tiled over the product surface, each cell coding both a local position and a page identifier. Thus, a pen arrangement is thus capable of directly detecting a logical position based on an image of such a coding pattern. Such a pen arrangement may access definition data to detect and identify aforesaid pidgets.

1. An electronic pen arrangement, comprising:
a position detector for detecting positions on a reference surface comprising a plurality of individually addressable position pages, each position being associated with a recording time;
a memory for holding definition data representing at least part of the reference surface, wherein the definition data defines at least one selection area on the reference surface; and
a position processor configured to map the detected positions against the definition data and to select, when identifying that a detected position falls within said at least one selection area, at least one of the position pages according to a temporal selection criterion.

2. The electronic pen arrangement of claim 1, wherein the temporal selection criterion is based on the recording times of the detected position within the selection area and one or more detected positions within the plurality of position pages.

3. The electronic pen arrangement of claim 2, wherein the temporal selection criterion defines a time window with respect to the recording time of the selection area position.

4. The electronic pen arrangement of claim 3, wherein the time window extends forwards in time from the recording time of the selection area position.

5. The electronic pen arrangement of claim 3, wherein the temporal selection criterion involves analyzing further positions detected within said time window.

6. The electronic pen arrangement of claim 5, wherein said analyzing involves finding the most recently detected position within the plurality of position pages, said most recently detected position identifying the selected position page.

7. The electronic pen arrangement of claim 5, wherein said analyzing involves finding the least recently detected position within the plurality of position pages, said least recently detected position identifying the selected position page.

8. The electronic pen arrangement of claim 1, wherein said at least one selection area is located outside the plurality of position pages.

9. The electronic pen arrangement of claim 1, wherein each selection area is associated with a predetermined action to be taken by the position processor with respect to the selected position page.

10. The electronic pen arrangement of claim 9, wherein said action comprises associating a data item with the selected position page.

11. The electronic pen arrangement of claim 10, wherein said action further comprises deriving said data item.

12. The electronic pen arrangement of claim 10, wherein said data item is included in the group consisting of: at least one position detected within said at least one selection area, a unique identifier of said at least one selection area, bar code data, audio data, image data, one or more machine-coded characters associated with one or more dedicated areas on the reference surface, and one or more parameter values pre-stored in said memory to indicate a property of the pen arrangement or a user thereof.

13. The electronic pen arrangement of claim 10, wherein said action further comprises associating each data item with a recording time.

14. The electronic pen arrangement of claim 10, further comprising a storage in which the position detector stores detected positions in association with their originating position page and the data item in association with the selected position page.

15. The electronic pen arrangement of claim 10, further comprising an interface which outputs the data item together with positions detected within the selected position page.

16. The electronic pen arrangement of claim 15, wherein the outputted data item is represented as positions within the selected position page.

17. The electronic pen arrangement of claim 16, wherein the outputted data item is represented as positions within a predetermined section of the selected position page where said position detector is unable to record valid positions.

18. The electronic pen arrangement of claim 9, further comprising a storage in which the position detector stores the detected positions in association with their originating position page, said action comprises deriving one or more positions stored in association with the identified position page from the storage.

19. The electronic pen arrangement of claim 18, wherein said action further comprises deleting the derived position from said storage.

20. The electronic pen arrangement of claim 1, wherein said definition data defines a set of temporal selection areas, each temporal selection area in said set having a unique identifier.

21. The electronic pen arrangement of claim 20, wherein each temporal selection area in said set is associated with an action causing the position processor to associate the identifier of the detected temporal selection area with the selected position page.

22. The electronic pen arrangement of claim 1, further comprising an MMI, wherein the position processor is caused to activate the MMI upon said identifying of a detected position within the selection area.

23. The electronic pen arrangement of claim 1, further comprising an MMI, wherein the position processor activates the MMI upon said selection of a position page.

24. The electronic pen arrangement of claim 1, wherein the position detector detects said positions based on images of a position-coding pattern which is arranged on a product surface.

25. A method in an electronic pen arrangement, comprising:
receiving positions detected on a reference surface comprising a plurality of individually addressable position pages, each position being associated with a recording time;
mapping the detected positions against definition data representing at least part of the reference surface, wherein the definition data defines at least one selection area on the reference surface; and
selecting, when identifying that a detected position falls within said at least one selection area, at least one of the position pages according to a temporal selection criterion.

26. The method of claim 25, further comprising identifying, for said selection area and based on said definition data, a predetermined action to be taken with respect to the selected position page.

27. The method of claim 26, further comprising executing said action, wherein said action comprises associating a data item with the selected position page.

28. The method of claim 27, wherein said action further comprises causing the electronic pen arrangement to derive said data item.

29. The method of claim 27, wherein said data item is included in the group consisting of: at least one position detected within said at least one selection area, a unique identifier of said at least one selection area, bar code data, audio data, image data, one or more machine-coded characters associated with one or more dedicated areas on the reference surface, and one or more parameter values pre-stored in a memory to indicate a property of the pen arrangement or a user thereof

30. The method of claim 27, wherein said action further comprises associating each data item with a recording time.

31. The method of claim 27, further comprising outputting the data item together with positions detected within the selected position page.

32. The method of claim 31, further comprising representing the outputted data item as positions within the selected position page.

33. The method of claim 32, further comprising representing the outputted data item as positions within a predetermined section of the selected position page where said electronic pen arrangement is unable to record valid positions.

34. The method of claim 25, further comprising activating an MMI upon said identifying a detected position within the selection area.

35. The method of claim 25, further comprising activating an MMI upon said selection of a position page.

36. A computer-readable storage medium, comprising a set of instructions which, when executed by a processor, performs the method as claimed in claim 25.

37. A device in an electronic pen arrangement, comprising:
a first input for receiving positions detected on a reference surface comprising a plurality of individually addressable position pages, each position being associated with a recording time;
a second input for accessing definition data representing at least part of the reference surface, wherein the definition data defines at least one selection area on the reference surface;
a page selector configured to map the detected positions against the definition data and to select, when identifying that a detected position falls within said at least one selection area, at least one of the position pages according to a temporal selection criterion.
